(19) United States
(12) Patent Application Publication
(10) Pub. No.: US 2014/0324775 A1
(43) Pub. Date: Oct. 30, 2014

(54) LOW-BANDWIDTH CROWD-SYNCHRONIZATION OF PLAYBACK INFORMATION

(71) Applicant: Robert O. Groover, III, Farmers Branch, TX (US)

(72) Inventor: Robert O. Groover, III, Farmers Branch, TX (US)

(21) Appl. No.: 14/218,892

(22) Filed: Mar. 18, 2014

Related U.S. Application Data
(60) Provisional application No. 61/793,450, filed on Mar. 15, 2013.

(51) Int. Cl. G06F 17/30

(52) U.S. Cl. CPC G06F 17/30578
USPC 707/614

(57) ABSTRACT

A portable media player which broadcasts synchronization data, but not streaming media content, for a media file which is currently being played. The media players are programmed, user-selectably, to synchronize to other media players which are already playing a desirable track.

The present application provides a new paradigm for portable entertainment unit operation, and corresponding methods and macro-systems.

Note that the points discussed below may reflect the hindsight gained from the disclosed inventions, and are not necessarily admitted to be prior art.

The numerous innovative teachings of the present application will be described with particular reference to presently preferred embodiments (by way of example, and not of limitation). The present application describes several inventions, and none of the statements below should be taken as limiting the claims generally.

Presently-available technology provides no easy way for two or more people to synchronize playback of a media file, e.g. an audio track. The best option generally available is for users to agree that, e.g., everyone will trigger playback at a pre-defined moment. Even so, however, this is limited by, e.g., differing reaction speeds of different people, and so playback is nearly impossible to synchronize perfectly. This asynchrony is only compounded as more people are added to the group attempting synchronization.

Further complications arise when device discrepancies are taken into account. Different devices can have slightly different playback speeds for the same file. This can mean that even initially perfectly-synchronized playback instances can gradually drift out of true as playback progresses.

### BRIEF DESCRIPTION OF THE DRAWINGS

The disclosed inventions will be described with reference to the accompanying drawings, which show important sample embodiments and which are incorporated in the specification hereof by reference, wherein:

FIG. 1 schematically shows one sample embodiment of playback synchronization according to the present inventions.

The present application teaches that low-bandwidth playback synchronization can be performed to permit real-time corrections to synchronized playback. Devices can broadcast enough playback information to permit synchronization without needing to broadcast the full file being synchronized.

This enables a new kind of cooperative social behavior. In a crowded setting, multiple people can coordinate dance movements, or can coordinate much more subtly if desired. (For instance, in a school environment, students might covertly coordinate finger or foot movements.) All of this can occur with absolutely no sound being audible by bystanders.

Sudden outbreaks of coordinated dance have been depicted in movies, and such group behavior gratifies human social feelings. The inventions disclosed here not only facilitate group dancing (or other gestural communications), but also permit exclusivity—for instance, the age of participants can be limited if desired. Thus the physical group interaction is exclusive and covert, while declaring itself by overt movements. This provides an ad hoc declaration of membership in an exclusive club.

Note that the participants do not have to plan in advance, and do not even have to be acquainted with each other. With appropriate protocols for linking (as described below), group size can increase at a dramatically exponential rate. Different participants can set their own rules for linking—e.g. “follow nobody,” or “follow high-ranked candidates of desired gender only,” or “follow only groups with 12 or more members already,” etc.

A user can declare a desired status by selection of these rules; for example, a would-be alpha female might set a “follow me” strategy, and might keep that strategy if and only if it is successful in attracting followers. A “lone wolf” personality might set preferences to follow nobody, and be content to have few or no followers.

In one class of embodiments, followers are only admitted to an ad hoc group if a rule-based test for approval is met. For example, a person who wants to join a group would send a ping, which might or might not be accepted.

The present application teaches that the files to be synchronized need not themselves be broadcast: only the minimal information necessary for synchronization needs to be broadcast to those who are joining the ad hoc group. This technical point is important to scalability: if rule-based connections and disconnections are used, an ad hoc group can scale very rapidly to hundreds or thousands of participants.

An important advantage of these systems and methods is that copyright infringement and media piracy can be completely prevented (within the users of this new technology), by requiring that all participants already possess a legitimate copy of the file to be synchronized. Even if more substantial bandwidth is used for the synchronization communication, this bandwidth is still significantly below that required to simply stream the media.

In one sample embodiment, the playback device can broadcast information to, for example, identify the specific media file being played, as well as e.g. playback location in the file, playback speed, and other data which can be used for synchronization depending on the particular media type. (For example, the implied location of the music source can provide one component of group cooperation.)

Playback location can be given as an “absolute” location, e.g. that playback is 36 s into an identified file which is 201 s long, or can be e.g. a location relative to the file length, e.g. that playback is at 17.2% of the file. Similarly, playback speed can also be expressed e.g. as an absolute speed (for example, that playback is progressing at 1.01× the “true” recorded speed of one second per second) or, more preferably, as a relative speed (e.g. a playback speed of +0.5% of the file per second).

This technology provides a simple way to implement group adherence and departure, for a kind of group behavior which gratifies many human instincts.

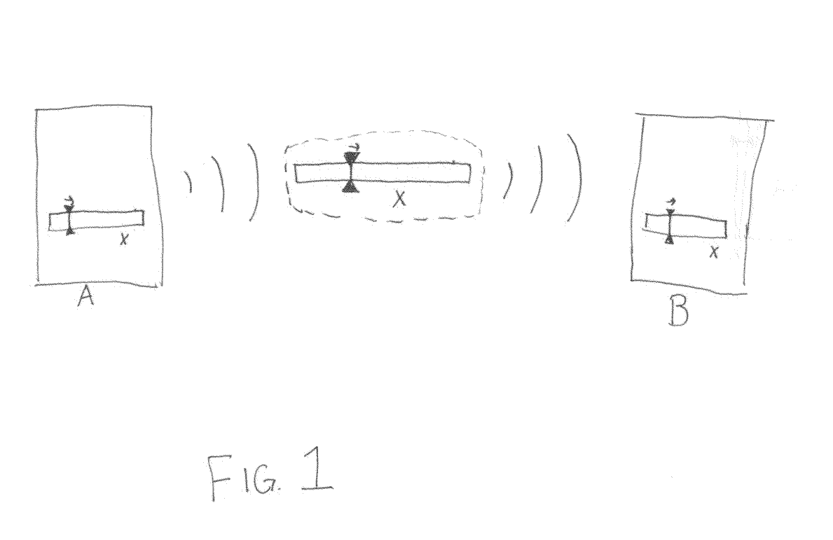

In one sample embodiment, one device can be the “master” device to which the other devices synchronize playback. In one example scenario, devices A and B are to synchronize playback of audio file X. Device A, which will act as the master device for synchronization, begins playing file X, and broadcasts synchronization information. Device B chooses to use this synchronization broadcast to begin playback of file X, starting from device A's current playback location. As the file plays, device B monitors device A's synchronization broadcast, self-correcting playback as needed to maintain synchronization. An example of this can be seen in FIG. 1.

Synchronization can be maintained in several different manners. In one sample embodiment, if device B falls behind device A in playback, B skips ahead in the file to A's current location, checks that playback is now synchronized, and continues playback. In another sample embodiment, device B can e.g. increase playback speed temporarily until devices A and B are once more synchronized, and then match playback speeds to device A.

Synchronization can also be much more sophisticated than simply matching playback locations and speeds. In some sample embodiments, analysis of e.g. current playback locations and file features can be performed to enable smart synchronization of files. In one such sample embodiment, devices A and B both communicate with database Q, which can maintain a master repository of files, e.g. through cloud backup of media files. Devices A and B can transmit current playback information to database Q, which can reply with any information needed to correct synchronization.

In one sample embodiment, instead of having a master device to which other devices synchronize, adjustments can instead be made to all synchronizing devices to minimize the adjustments that must be made by any single device.

In one sample embodiment, all synchronizing devices can broadcast synchronization information to confirm synchronization.

Note that the use of synchronization information only, as opposed to streaming media, is another factor in scalability. If the unique identification of a media file is combined with start time and tempo, this provides a small amount of data which (with a group identifier, or an indication of group adherence rules) can be broadcast asynchronously. It does not matter if the tenth and the millionth devices do not receive the synchronization information at the same instant: once they have all received the same synchronization information, they are all perfectly synchronized.

This is not only applicable to audio files, but also to video and to 3D virtual realities. In each case a unique identifier for the media permits perfect synchronization.

### Modifications and Variations

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims.

In one contemplated embodiment, media piracy can be combatted by requiring that all devices involved in synchronization own a legal copy of the file being synchronized. This can be done, for example, by having different media players verify each other.

The topology of the ad hoc network can vary in several ways. The simplest is to bind a group to the person who launched it; alternatively, succession rules can be used to pass leadership to the second member, then the third, etc.

Note also that different rules can be used for whether to broadcast synchronization data for possible adherents at various times and places.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A portable media player
which is able to play entertainment media, and to provide media track content through transducers to the sense organs of a human user;
which is programmed to broadcast the unique identifier for whichever media track is being played, together with synchronization data which indicates precisely what the playback point is, for any given time.

2. A portable media player
which is able to play entertainment media, and to provide media track content through transducers to the sense organs of a human user;
which is programmed to broadcast the unique identifier for whichever media track is being played, together with synchronization data which indicates precisely what the playback point is, for any given time;
and which is programmed to synchronize, under at least some circumstances, to the unique identifier and synchronization data which has been broadcast by another media play, if the unique identifier corresponds to media content which the user can legally play.

3. A portable media player which is programmed to play entertainment media tracks having unique identifiers, and to broadcast synchronization data, at least sometimes, for whichever track is currently being played.
